(19) United States
(12) Patent Application Publication
(10) Pub. No.: US 2003/0055618 A1
(43) Pub. Date: Mar. 20, 2003

(54) Process variable identification method, process variable identification apparatus, and evaluation sample

(75) Inventor: Hiroo Masuda, Tokyo (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Semiconductor Technology Academic Research Center

(21) Appl. No.: 10/247,440

(22) Filed: Sep. 18, 2002

(30) Foreign Application Priority Data
Sep. 18, 2001 (JP) 2001-283932

(51) Int. Cl. G06F 17/10

(52) U.S. Cl. 703/2

(57) ABSTRACT

The present invention includes calculating an inter-wiring capacitance from process variables including a structural variable and a material constant of each interlayer insulating film in a multi-wiring structural including a first wiring layer, a second wiring layer having a pluraltiy of pitch wirings with a width W arranged at a pitch P, a third wiring layer and a pluraltiy of interlayer insulating films which insulate and separate the first to third wiring layers from each other, modeling a function expression in which the process variables are determined as variables and the inter-wiring capacitance is determiend as a response variable from the relationship between the obtained inter-wiring capacitance and the process variables, creating actual multi-layer wiring structures and measuring an inter-wiring capacitance from each created multi-layer wiring structure, and identifying the process variables of the actually formed multi-layer wiring structure from the measured inter-wiring capacitances based on the modeled function expression.

### CROSS-REFERENCE TO RELATED APPLICATIONS

This application is based upon and claims the benefit of priority from the prior Japanese Patent Application No. 2001-283932, filed Sep. 18, 2001, the entire contents of which are incorporated herein by reference.

### BACKGROUND OF THE INVENTION

1. Field of the Invention

The present invention relates to a process variable identification method and a process variable identification apparatus used for obtaining a structure constant and a material constant of an interlayer insulating film in a multi-layer wiring structure, and an evaluation sample used in this process variable identification method.

2. Description of the Related Art

A calculation of an inter-wiring capacity has been conventionally carried out by performing two-dimensional or three-dimensional field analysis with respect to various kinds of wiring structures. In this occasion, an effective dielectric constant, a film thickness and an electrode shape of an interlayer insulating film, and a three-dimensional shape in case of a multi-layer insulating film must be known in advance. The structure constant and the material constant ideally do not depend on a wiring structure, are presumed as constant and identified by means which measures a typical test structure (TEG: test element group) by using a cross section TEM or analogizes the same from an electrical capacity value obtained from a TEG having a large area.

In the above-described method, a large area is required for the TEG, and there is also a problem that accurate evaluation is impossible since a sampling error of a material constant (effective dielectric constant) is determined by the measurement accuracy of a very thin interlayer insulating film.

Further, it is expected that a material constant of an insulating film formed between fine pitch wirings is different from the counterpart formed between parallel flat plates each having a large area (quality of material is different). However, measuring a material constant of an insulating film formed between pitch wirings has been conventionally impossible. Furthermore, although the wiring structure can not be necessarily ideally rectangular in actual fine wirings, identification of the cross-sectional structure, analysis and measurement of the influence on the material constant of the inter-wiring insulating film are becoming impossible.

Moreover, when trying to accurately measure by using the cross-sectional TEM, it requires more time and labor to produce a sample to be measured, and evaluating a distribution in which many samples are used is actually impossible.

### BRIEF SUMMARY OF THE INVENTION

It is an object of the present invention to provide a process variable identification method and a process variable identification apparatus which can accurately obtain a material constant and a structure constant of an interlayer insulating film in a multi-layer wiring structure, and an evaluation sample used in this process variable identification method.

To achieve this aim, the present invention is configured as follows.

(1) According to the present invention, there is provided a process variable identification method comprising, with respect to a multi-layer wiring structure including a first wiring layer consisting of a plane electrode, a second wiring layer which is arranged on the first wiring layer and has a plurality of pitch wirings with a width W arranged with a pitch P, a third wiring layer which is arranged on the second wiring layer and consists of a plane electrode and a plurality of interlayer insulating films which respectively insulate and separate the first to third wiring layers from each other: a step of calculating an inter-wiring capacity from process variables including at least a structure variable and a material constant of each interlayer insulating film; a step of modeling a function expression in which the process variables are determined as variables and the inter-wiring capacity as a response variable based on the relationship between the obtained inter-wiring capacity and the process variables; a step of creating a plurality of multi-wiring structures having widths of the pitch wirings or pitches different form each other and measuring an inter-wiring capacity from each created multi-layer wiring structure; and step of identifying the process variables of the actually formed multi-layer wiring structure from the measured inter-wiring capacities based on the modeled function expression.

(2) According to the present invention, there is provided a process variable identification method comprising, in a multi-layer wiring structure including a first wiring layer consisting of a plane electrode, a second wiring layer which is arranged on the first wiring layer and has a plurality of pitch wirings with a width W arranged with a pitch P, a third wiring layer which is arranged on the second wiring layer and consists of a plane electrode and a plurality of interlayer insulating films which respectively insulate and separate the first to third wiring layers from each other: a step of calculating a plurality of relationships between structure constants and material constants of respective interlayer insulating films and respective capacities between wiring layers; a step of measuring inter-wiring capacities between respective wirings of the actually formed multi-layer wiring structure; and a step of selecting an inter-wiring capacity which coincides with a measured capacity from the calculated inter-wiring capacities and identifying a process variable corresponding to the selected inter-wring capacity as a process variable of the actually formed multi-layer wiring structure.

(3) According to the present invention, there is provided a process variable identification apparatus comprising, with respect to a multi-layer wiring structure including a first wiring layer consisting of a plane electrode, a second wiring layer which is arranged on the first wiring layer and has a plurality of pitch wirings with a width W arranged with a pitch P, a third wiring layer which is arranged on the second wiring layer and consists of a plane electrode and a plurality of interlayer insulating films which respectively insulate and separate the first to third wiring layers from each other: a capacity calculation portion which calculates an inter-wiring capacity from process variables including at least a geometric shape and a material constant of each interlayer insulating film; a function expression generation portion which models a function expression in which the process variables are determined as variables and the inter-wiring capacity is determined as a response variable from the relationship between the obtained inter-wiring capacity and the process variables; an inter-wiring capacity measurement portion which measures an inter-wiring capacity between respective wirings from the actually formed multi-layer wiring structure; and means for identifying the process variables from the function expression modeled in the function expression generation portion and the inter-wiring capacity measured in the inter-wiring capacity measurement portion.

(4) According to the present invention, there is provided a process variable identification apparatus comprising, in a multi-layer wiring structure including a first wiring layer consisting of a plane electrode, a second wiring layer which is arranged on the first wiring layer and has a plurality of pitch wirings with a width W arranged with a pitch P, a third wiring layer which is arranged on the second wiring layer and consists of a plane electrode and a plurality of interlayer insulating films which respectively insulate and separate the first to third wiring layers from each other: a capacity calculation portion which calculates a plurality of relationships between process variables including at least a geometric shape and a material constant of each interlayer insulating film and each capacity between wiring layers; a capacity measurement portion which measures an inter-wiring capacity between respective wirings from the actually formed multi-layer wiring structure; and an identification portion which selects an inter-wiring capacity which coincides with the inter-wiring capacity measured in the capacity measurement portion from the inter-wiring capacities calculated in the capacity calculation portion and identifies the process variables of the actually formed multi-layer wiring structure based on the identified inter-wiring capacity.

(5) According to the present invention, there is provided an evaluation sample comprising a plurality of TEGs each of which includes: a first wiring layer consisting of a plane electrode; a second wiring layer which is arranged on the first wiring layer and has a plurality of pitch wirings arranged with a predetermined pitch; a third wiring layer which is arranged on the second wiring layer and consists of a plane electrode; and a plurality of interlayer insulating films for a plurality of layers, which respectively insulate and separate the first to third wiring layers from each other, a plurality of the TEGs having widths of the pitch wirings or the pitches different from each other.

As described above, according to the present invention, by measuring an electrical capacitance between wiring layers using a plurality of pitch wiring TEGs, it is possible to easily and accurately identify a structural constant and a material constant of a fine wiring structure which cannot be measured/identified in the prior art.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIGS. 1A to 1C are cross-sectional views showing a schematic structure of a TEG formed in an evaluation sample according to a first embodiment;

FIG. 2 is a block diagram showing an identification apparatus for a structure constant and a material constant of an interlayer insulating film according to the first embodiment;

FIG. 3 is a block diagram showing an identification method for a structure constant and a material constant, which uses the identification apparatus depicted in FIG. 2;

FIGS. 4A and 4B are views showing an example of an experimental table used in the first embodiment;

FIGS. 5A and 5B are views showing an example of the experimental table used in the first embodiment;

FIGS. 6A and 6B are views showing an example of the experimental table used in the first embodiment;

FIG. 7 is a characteristic view showing a result of verifying errors of structure and material constants identified based on a response function Fij and measurement data of the capacity;

FIGS. 8A and 8B are views showing an example of a structure of a second wiring layer illustrated in FIGS. 1A to 1C;

FIGS. 9A and 9B are views showing an example of the structure of the second wiring layer illustrated in FIGS. 1A to 1C;

FIGS. 10A to 10C are cross-sectional views showing a schematic structure of a TEG having a structure different from that of the TEG depicted in FIGS. 1A to 1C;

FIGS. 11A and 11B are views showing an example of the structure of the second wiring layer of the TEG illustrated in FIGS. 1A to 1C;

FIG. 12 is a block diagram showing an identification apparatus for a structure constant and a material constant of an interlayer insulating film according to the first embodiment; and

FIG. 13 is a block diagram showing an identification method for a structural constant and a material constant, which uses the identification apparatus illustrated in FIG. 12.

### DETAILED DESCRIPTION OF THE INVENTION

Embodiments according to the present invention will now be described hereinafter with reference to the accompanying drawings.

(First Embodiment)

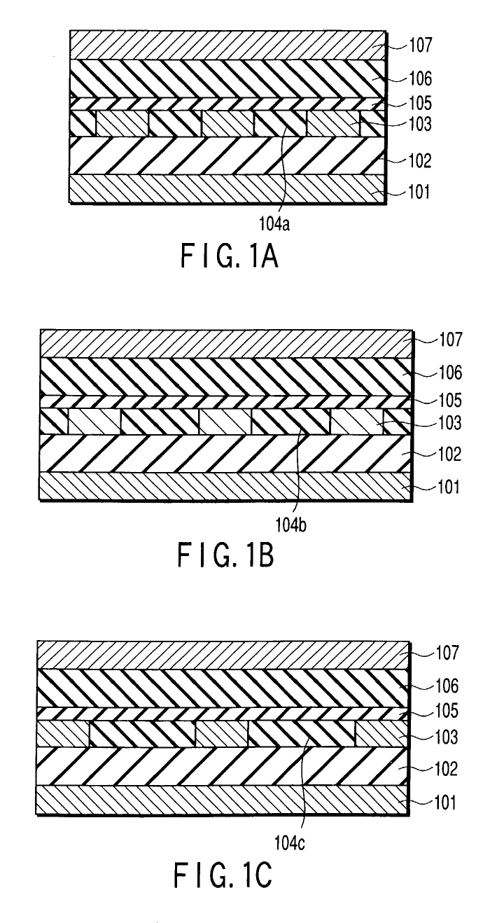

FIGS. 1A to 1C are cross-sectional views showing a schematic structure of a TEG formed in an evaluation sample according to a first embodiment of the present invention.

A first wiring layer 101 consisting of a plane electrode is formed on a non-illustrated substrate. A first interlayer insulating film 102 is formed on the first wiring layer 101. A plurality of second wiring layers 103 are formed on the first interlayer insulating film 102. Second interlayer insulating films 104 (104a to 104c) are formed on the first interlayer insulating film 102 and between the second wiring layers 103. A third interlayer insulating film 105 is formed on the second wiring layers 103 and the second interlayer insulating films 104. A fourth interlayer insulating film 106 is formed on the third interlayer insulating film 105. A third wiring layer 107 consisting of a plane electrode is formed on the fourth interlayer insulating film 106.

It is to be noted that widths W of the second wiring layers 103 are designed to be identical in the TEGs shown in FIGS. 1A to 1C. In the TEGs depicted in FIGS. 1A to 1C, however, widths of the respective second interlayer insulating films 104a to 104c are different from each other, and pitches of the second wiring layers 103 are different from each other. In this embodiment, a mask is designed in such a manner that the second wiring layers 103 in the TEG shown in FIG. 1A are arranged with a pitch P; the second wiring layers in the TEG shown in FIG. 1B, a pitch 2P; and the second wiring layers in the TEG shown in FIG. 1C, a pitch 3P. In the proximity effect or the like in an exposure process, however, a wiring width W actually formed to a sample is W+ΔW in each example. This quantity of total displacement ΔW is a variable which varies depending on a used exposure apparatus or the like.

Further, a film thickness Ti and a dielectric constant ε1 of the first interlayer insulating film 102, a film thickness T2 and a dielectric constant ε2 of each second interlayer insulating film 104, a film thickness T3 and a dielectric constant ε3 of the third interlayer insulating film 105, and a film thickness T4 and a dielectric constant ε4 of the fourth interlayer insulating film 106 are unknown.

In such a structure, four types of electrical capacities are formed to each sample. Therefore, a total of 12 types of capacities can be measured with three types of the TEGs. It is assumed that a capacity between the first wiring layer 101 and the second wiring layers 103 is C12, a capacity between the second wiring layers 103 and the third wiring layer 107 is C23, an inter-wiring capacity of adjacent second wiring layers 103 is C22, and a capacity between the first wiring layer 101 and the third wiring layer 107 is C13. It is well known that values of these capacities Cij (i, j=1 to 3) are quantities which vary depending on the dielectric constants ε1 to ε4 and the film thicknesses T1 to T4. Here, Cij (i, j=1 to 3) are values which are not completely independent from each other, and C13 is a value calculated from other measurement values. In 12 types of the capacities to be measured, therefore, there are nine types of the capacities which are independent from each other.

Here, each capacity value Cij can be generally represented by the following analytic function expression:

Cij=Fij (T1 to T4, ε1 to ε4, ΔW)

i and j are each 1, 2 or 3

Here, Fij is a function composed of nine variables, i.e., the film thicknesses T1 to T4, the dielectric constants ε1 to ε4 and a quantity of total displacement ΔW.

This Fij (T1 to T4, ε1 to ε4, ΔW) can be expressed by using a function based on statistical theory. For example, as Fij, the nine variables T1 to T4, ε1 to ε4, ΔW (here, notation of X1 to X9 is used in place of the nine variables T1 to T4, ε1 to ε4, ΔW) can be expressed as follows in the form of a linear function:

Cij=b0+b1×X1+b2×X2+b3×X3+b4×X4+b5×X5+b6×X6+b7×X7+b8×X8+b9×X9

Furthermore, it can be expressed as follows in the form of a quadric function:

Cij+b₀×b₁×X₁+b₂×X₂+b₃×X₃+b₄×X₄+b₅×X₅+b₆×X₆+b₇×X₇+b₈×X₈+b₉×X₉+b₁₁>X₁²+b₂₂×X₂²+b₃₃×X₃²+b₄₄×X₄²+b₅₅×X₅²+b₆₆×X₆²+b₇₇×X₇2+b₈₈×X₈² b₃₉×X₃×X₉+b₄₅×X₄×X₅+b₄₆×X₄×X₆+b₄₇×X₄×X₇+b₄₈×X₄×X₈+b₄₉×X₄×X₉+b₅₆×X₅×X₆+b₅₇×X₅×X₇+b₅₈×X₅×X₈+b₅₉×X₅×X₉+b₆₇×X₆×X₇+b ₆₈×X₆×X₈+b₆₉×X

T4, ε1 to ε4, ΔW can be mathematically determined by measuring nine types of capacities Cij from the three types of TEG samples shown in FIGS. 1A to 1C. Therefore, this embodiment can reveal that the structure/material constants T1 to T4, ε1 to ε4, ΔW of the respective interlayer insulating films 102, 104, 105 and 106 can be identified even if there is no inline measurement data of the process in advance.

Description will now be given as to a method for obtaining the above-described Fij (T1 to T4, ε1 to ε4, ΔW) and a method for obtaining the structure/material constants T1 to T4, ε1 to ε4, ΔW of each interlayer insulating film from capacity measurement values.

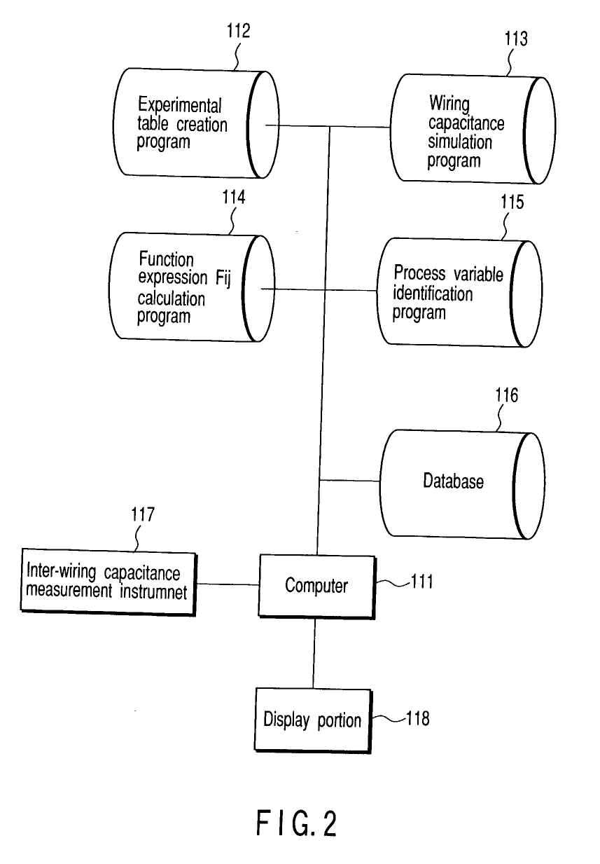

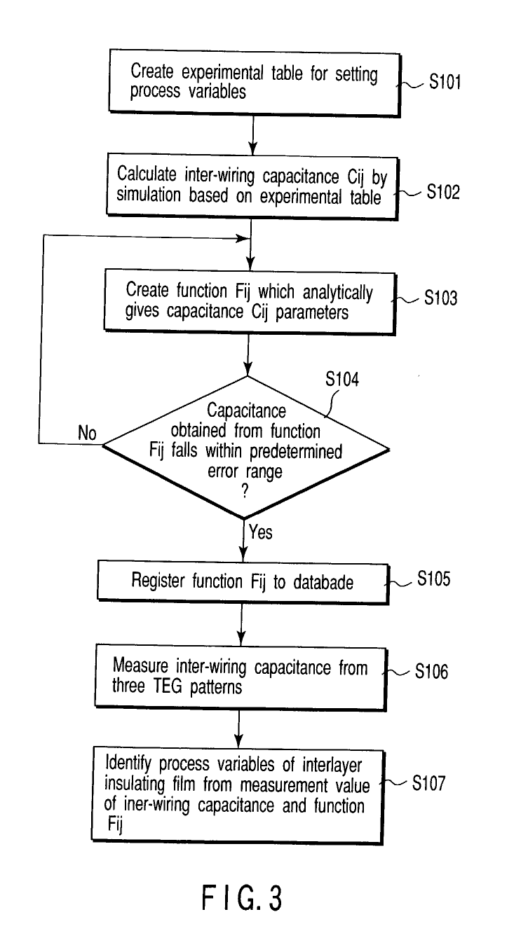

FIG. 2 is a block diagram showing an apparatus which calculates the structure/material constants of each interlayer insulating film in a multi-layer wiring structure according to the first embodiment of the present invention. FIG. 3 is a block diagram showing an identification apparatus for structure constants and material constants of each interlayer insulating film in the multi-layer wiring structure according to the first embodiment of the present invention.

It is to be noted that, in the apparatus shown in FIG. 2, a computer 111 carries out execution of respective programs 112 to 114, read/write control of a data base 116, and control of an inter-wiring capacity measurement instrument 117 and a display portion.

(Steps S101)

In this embodiment, in order to perform systematic multi-dimensional capacity analysis, an experimental table creation program 112 is used to create an experimental design table in which a plurality of combinations of a film thickness and a dielectric constant of each interlayer insulating film and ΔW as process variables of the analysis simulation are registered, and the experimental design is made. The created experimental table is registered in the data base 116.

In order to create the experimental design table, for example, a CCC, a Box-Benken table or the like which is a well-known experimental design table can be utilized in accordance with a number of process variables.

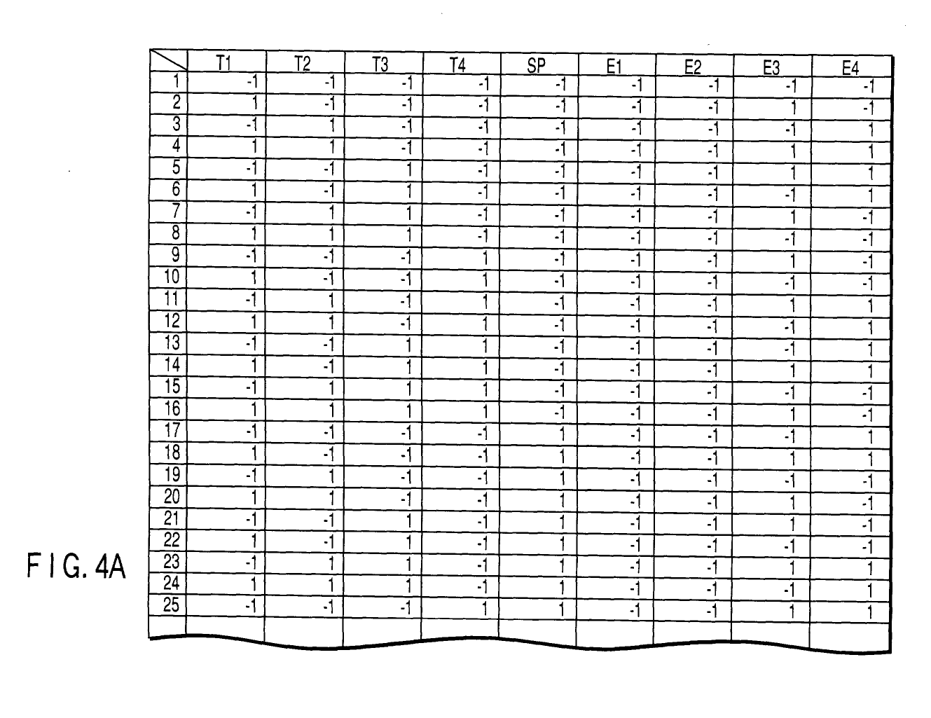

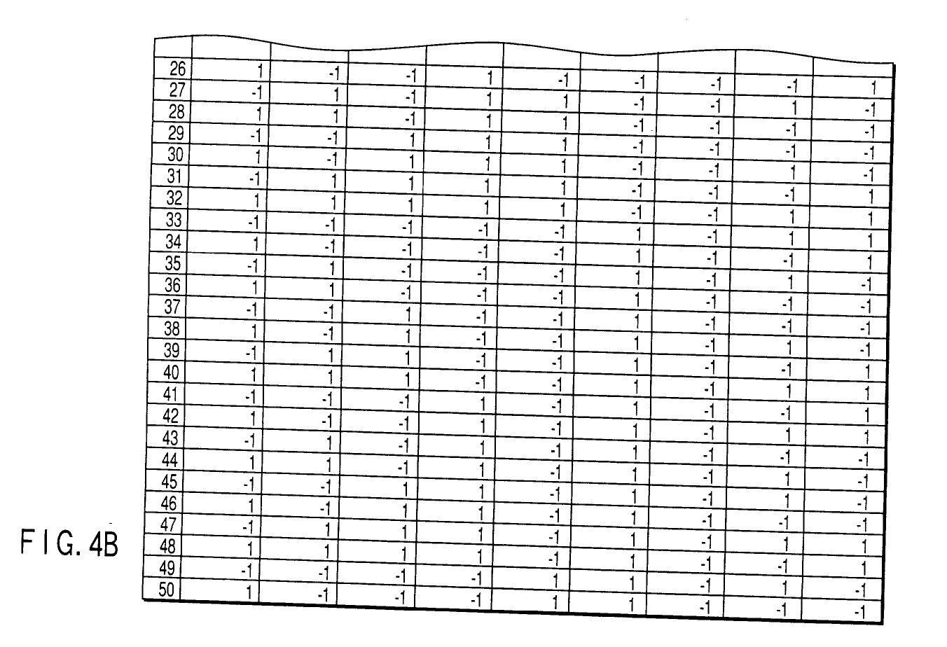

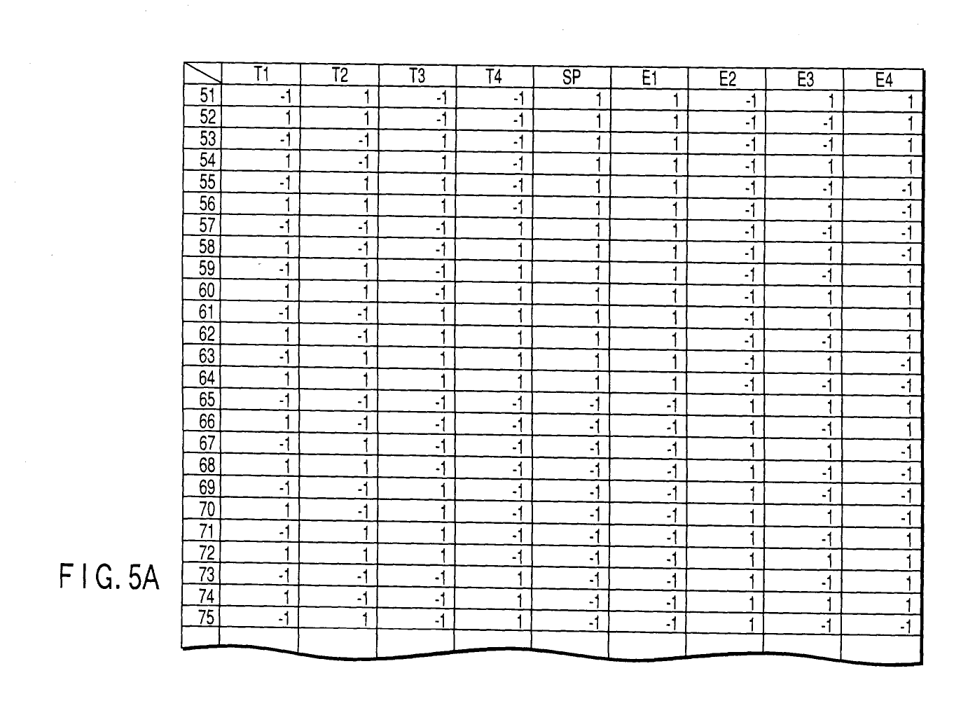

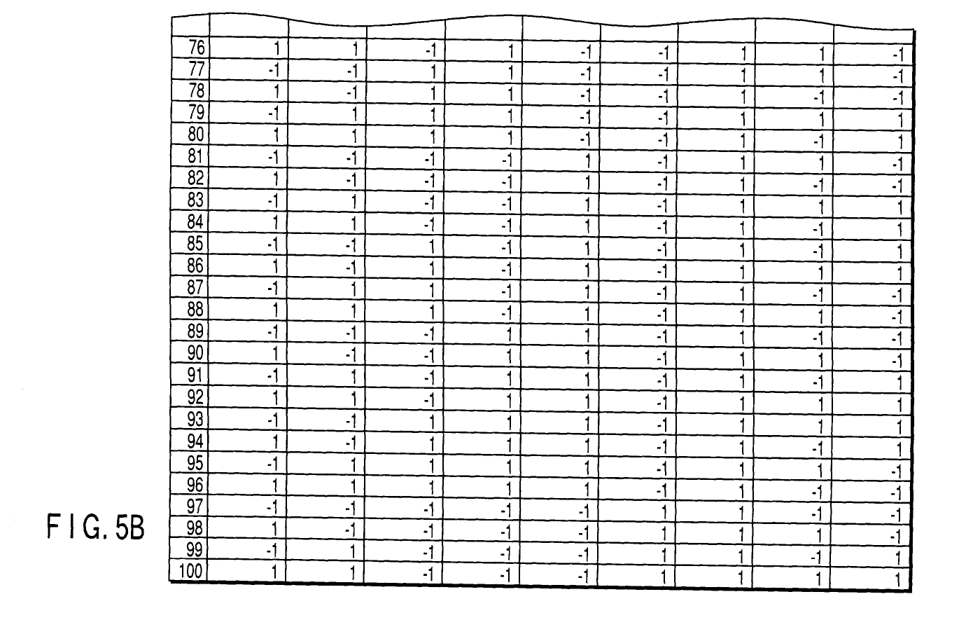

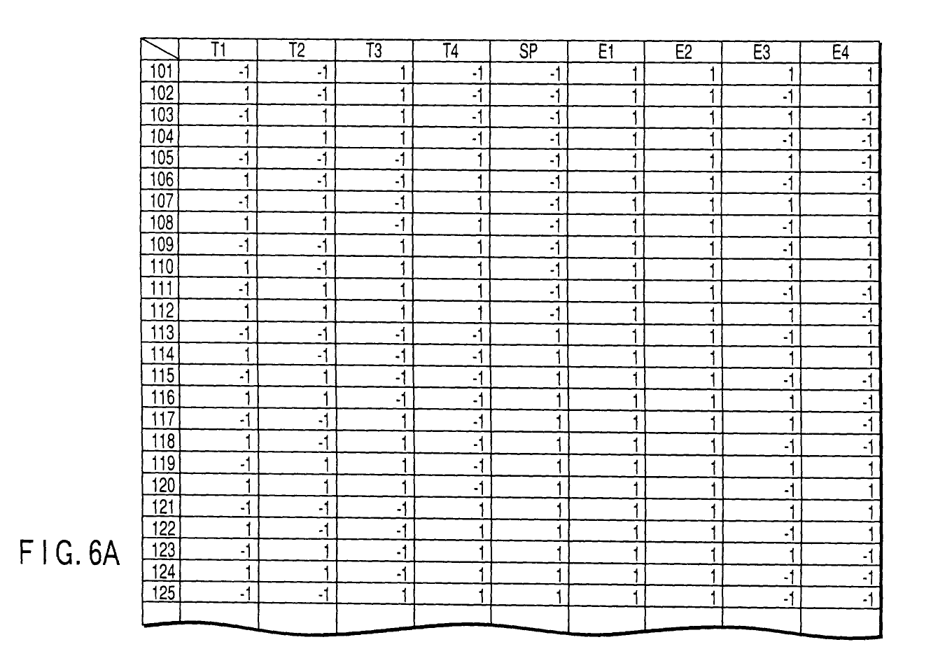

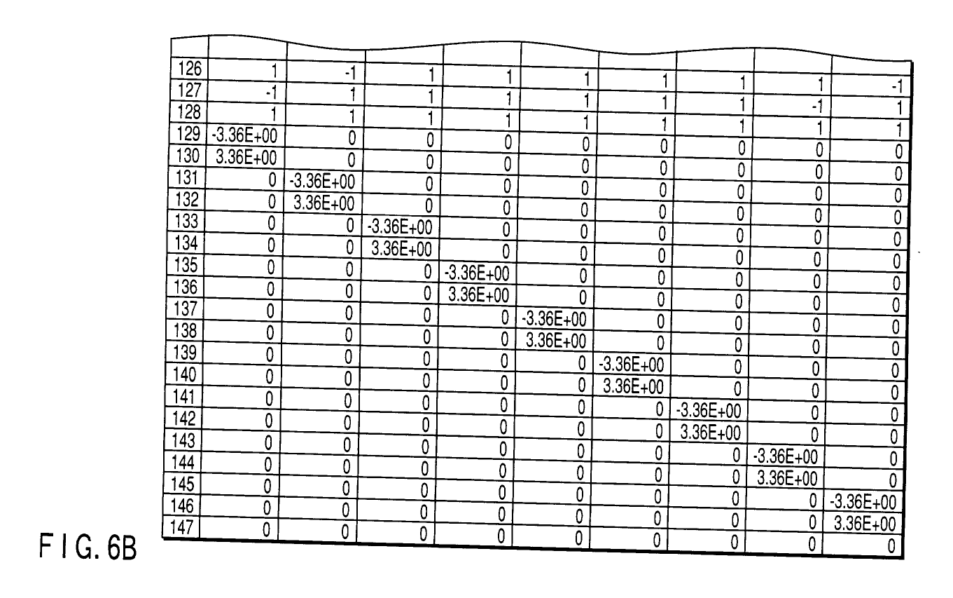

FIGS. 4A to 6B show an example of a CCC design table of nine variables as an instance of the experimental table. Values 0, −1 and +1 in this table indicate standardized values of respective variables. For example, 0 is set to a mean value of variables, −1 is set to a minimum value of irregularities of variables (threefold of mean value—irregularity standard deviation), and +1 is set to a minimum value of irregularities of variables (threefold of the mean value+mean value+irregularity standard deviation).

(Step S102)

Based on the experimental design table, the inter-wiring capacity simulation program 113 is used and the capacities Cij are systematically calculated. Moreover, the capacities Cij with respect to the process variables T1 to T4, ε1 to ε4, ΔW are registered in the data base 116. As the inter-wiring capacity simulation program 113, there is used a program which obtains the capacities Cij by performing numerical analysis of, e.g., the Poisson equation.

(Step S103)

A result of calculation is used, and function expressions Fij which describe the relationship between the capacities Cij and the process variables are determined based on the respective process variables and the capacities Cij registered in the data base 116 by using the function expressions Fij calculation program 114. In order to further accurately obtain the above-described parameter variables (bm, bmn), it is preferable to express Cij =Fij (T1 to T4, ε1 to ε4, ΔW) in the quadric function.

Response variables are C12, C22 and C23, and quantities such as shown in FIGS. 4A to 6B are used. Here, Sp=P−ΔW and Ei=εi (1 to 4) are established, and it is good enough to perform variable conversion with respect to some of the process variables in order to improve the accuracy of the data base and that of the response function expression Fij. For example, since the capacity is in inverse proportion to the film thickness, 1/Ti should be Xi.

(Step S104)

By using the function expression Fij calculation program 114, judgment is made upon whether an error between the capacity Cij with respect to the process variable registered in the data base 116 and the capacity obtained by substituting the process variable for the obtained Fij falls within a predetermined range (for example, ±2%).

If it was found that the error exceeds a predetermined range as a result of judgment, the processing returns to the step S103 and the above-described variable conversion or the like is carried out. This is repeated until the function expression Fij by which the error falls within a predetermined range is obtained.

(Step S105)

If it was found that the error falls within a predetermined range as a result of the step S104, the function expression Fij itself is again registered in the data base 116.

(Step S106)

A multi-layer wiring structure having the TEG patterns shown in FIGS. 1A to 1C is formed by using a predetermined process. The nine inter-wiring capacities Cij are measured based on each created TEG pattern by using the inter-wiring capacity measurement instrument 117. Here, it is assumed that capacities obtained from the first TEG pattern shown in FIG. 1A are C112, C123 and C122; capacities obtained from the second TEG pattern shown in FIG. 1B, C212, C223 and C222; and capacities obtained from the third TEG pattern shown in FIG. 1C, C312, C323 and C322.

(Step S107)

Film thicknesses T1 to T4, dielectric constants ε1 to ε4 of each interlayer insulating film and ΔW are identified by using a film thickness/dielectric constant identification program 115. This step will be concretely described hereinafter. A simultaneous equation with nine unknowns is created by substituting the inter-wiring capacitances Cij measured from the respective measured TEG patterns for Fij registered in the database.

$$\{ \begin{matrix}{C}_{112} = {F}_{12} ( {X}_{1} , X2 , X3 , X4 , X5 , X6 , X7 , X8 , X9 ) \\ {C}_{122} = {F}_{22} ( {X}_{1} , X2 , X3 , X4 , X5 , X6 , X7 , X8 , X9 ) \\ {C}_{123} = {F}_{23} ( {X}_{1} , X2 , X3 , X4 , X5 , X6 , X7 , X8 , X9 ) \\ {C}_{212} = {F}_{12} ( {X}_{1} , X2 , X3 , X4 , X5 , X6 , X7 , X8 , X9 ) \\ {C}_{222} = {F}_{22} ( {X}_{1} , X2 , X3 , X4 , X5 , X6 , X7 , X8 , X9 ) \\ {C}_{223} = {F}_{23} ( {X}_{1} , X2 , X3 , X4 , X5 , X6 , X7 , X8 , X9 ) \\ {C}_{312} = {F}_{12} ( {X}_{1} , X2 , X3 , X4 , X5 , X6 , X7 , X8 , X9 ) \\ {C}_{322} = {F}_{22} ( {X}_{1} , X2 , X3 , X4 , X5 , X6 , X7 , X8 , X9 ) \\ {C}_{323} = {F}_{23} ( {X}_{1} , X2 , X3 , X4 , X5 , X6 , X7 , X8 , X9 )\end{matrix}$$

Further, the simultaneous equation is solved, and the film thicknesses T1 to T4 and the dielectric constants ε1 to ε4 of each interlayer insulating film and ΔW are obtained. This calculation is a simple mathmatical calculation and can be executed in a short time.

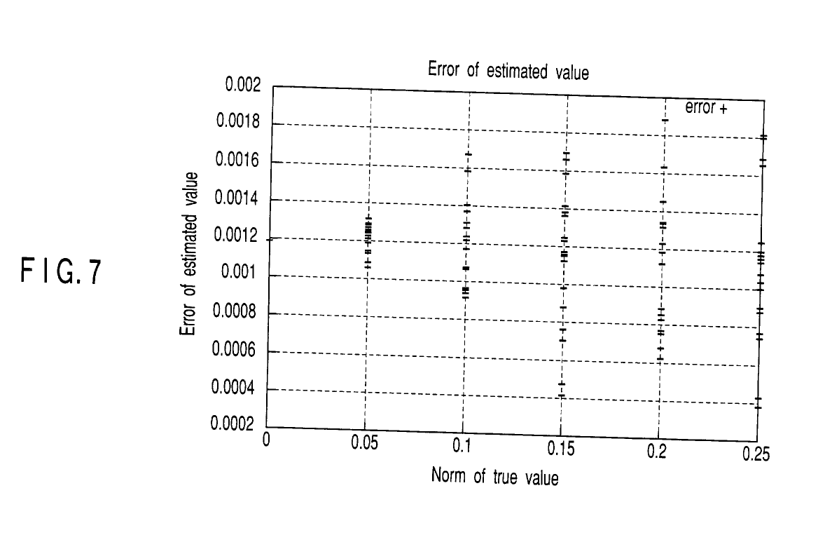

FIG. 7 is a characteristic view showing a result of verifying errors of structure and material constants identified from the response functions Fij and the measurement data of the capacity.

Here, in FIG. 7, a horiozntal axis represents a difference (standardized numeric value) between a true measurement value and an initial condition value, and a vertical axis represents an error (relative value) of a sampled value as a true measurement value. For example, when the horizontal axis=0.1, namely, each variable is a standardized value and a value which is greater than a true measurement value by 0.1 is sampled as an initial value, an error of the sampled value falls within a range of 0.09% to 0.17% and it can be understood the true measurement value can be saccessfully calculated.

It was proved that the error can be set to 0.2% or lower and it was verified that the present invention can demonstrate the actual effect.

As described above, by measuring the electrical capacity between the wiring layers using a plurality of the pitch wiring TEGs, it is possible to easily and accurately identify the fine wiring structure and material constants which can not be accurately measured/identified in the prior art.

Each of the TEG patterns shown in FIGS. 1A to 1C has an area which is small for the TEG pattern and is taken as a scribe TEG.

Although three-dimensional wiring data can be described only with ideal wiring dimensions and material constants (dielectric constants) in the prior art, detailed and quantitative wiring dimensions and material constants can be sampled at the stage of trial production of the TEG. Therefore, further accurate process inforamtion can be provided to a designer as a design manual, and irregularities in the electrical characteristic with respect to fluctuations of each dimension/material constant can be quantitatively analyzed, thereby readily creating basic data used for appropriately performing the margin design.

Accordingly, it is possible to provide means which enables analysis of irregularities in the characteristic of the wiring system process and carry out with an appropriate design margin the design technique which sets a too large margin in the prior art.

Some examples of the structure of the second wiring layer will now be described hereinafter.

### FIRST EXAMPLE

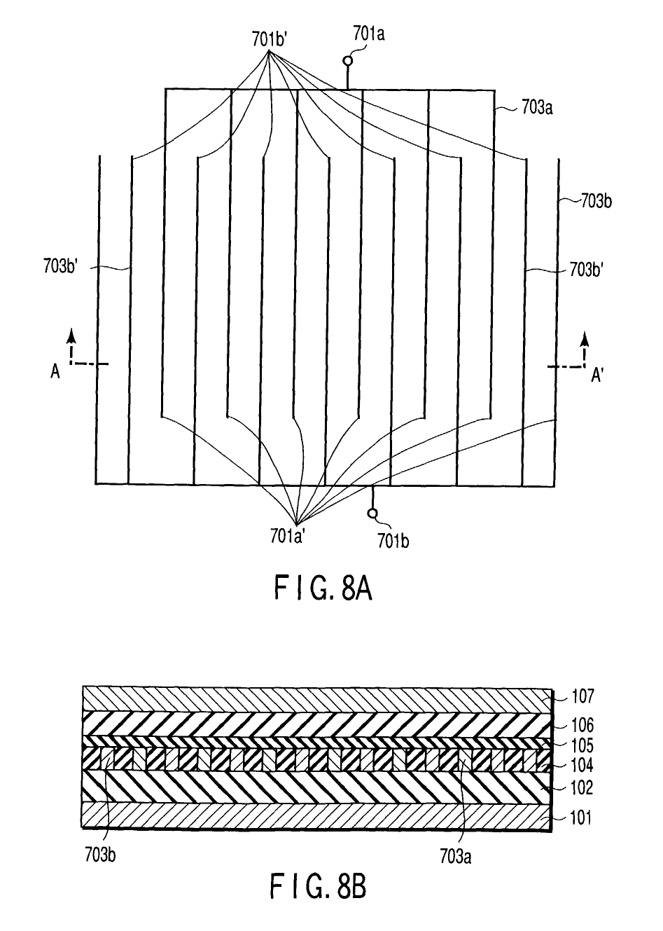

FIGS. 8A and 8B are views showing an example of the structure of the second wiring layer of the TEGs illustrated in FIGS. 1A to 1C. FIG. 8A is a plane view showing the structure of the second wiring layer, and FIG. 8B is a cross-sectional view taken along the portion A-A′ in FIG. 8A.

In this embodiment, as shown in FIG. 8A, the second wiring layer has a comb-like shape. In the second wiring layer having such a shape accroding to this embodiment, a wiring 703a connected to an electrode terminal 701a and a wiring layer connected to an electrode terminal 701b are alternately arranged. When measuring the capacity, the capacity C22 can be accurately obtained by measring the capacity between the two electrode terminals 701a and 701b. Since the edge effect of opposed electrode terminals 701a′ and 701b′ can be ignored by setting the length of the opposed parts of the electrode terminal 701a and the electrode terminal 701b sufficiently longer tha an interval of the opposed parts, the capacity C22 can be accurately obtained.

Here, although two wirings 703b are arranged on the outermost side connected to the electrode terminal 701b, an object is to suppress the disorder of the process working at the outermost portion of the regular wiring pitch by this arrangement, and there can be thereby obtained an advantage that the measurement accuracy of the capacity C22 can become more accurate. Since the regularity of the pattern is disturbed at the both ends, the measurement accuracy of the capacity C22 can become more accurate. For example, if there is no wiring 703b, there occurs a phenomenon that the wiring 703b′ becomes thinner than any other wiring.

### SECOND EXAMPLE

FIGS. 9A and 9B are views shwoing an example of the structure of the second wiring layer of the TEG samples shown in FIGS. 1A to 1C. As shown in FIGS. 9A and 9B, this example is characterized in that there are generated two types (2L and 2L′) of the TEG samples having different overlapping lengths (opposing lengths) of the wiring 703a (703a′) and the wiring 703b (703b′). It is to be noted that the width and the pitch of the respective wirings are the same.

By taking a difference in the capacity Cij obtained from the both TEG samples, it is possible to obtain the capacity Cij in which the parasitic effect of the external wirings and the bonding pad is completely removed.

As a result, in the forgoing embodiment and the first example, a relatively long opposing length is required in order to minimize the influence of the above-descried parasitic effect. According to this embodiment, however, the opposing length of the second wiring layer can be shortened, and the effect of reduction in the TEG area can be obtained.

### THIRD EXAMPLE

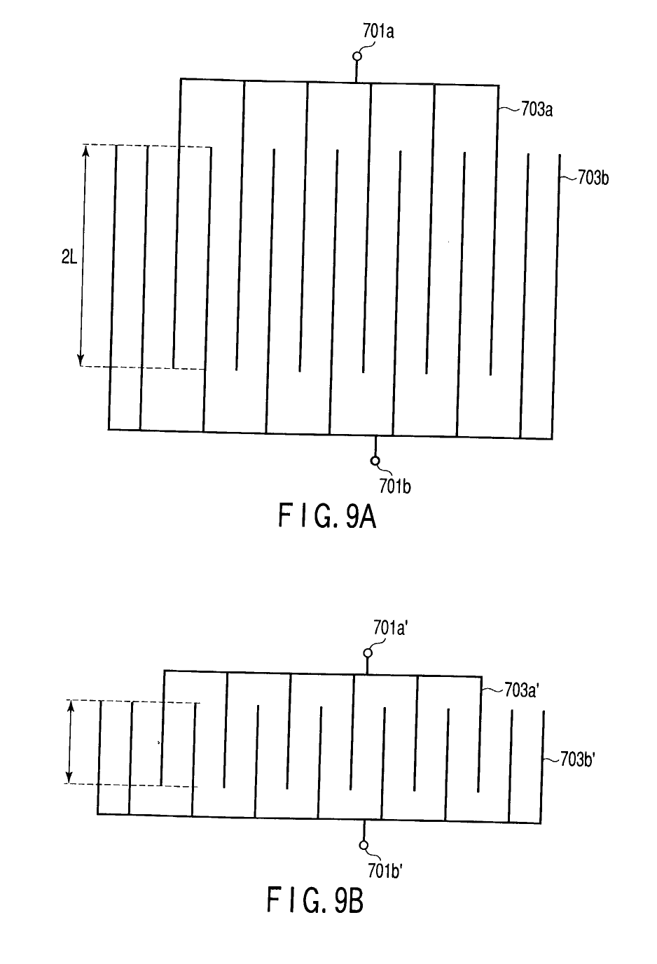

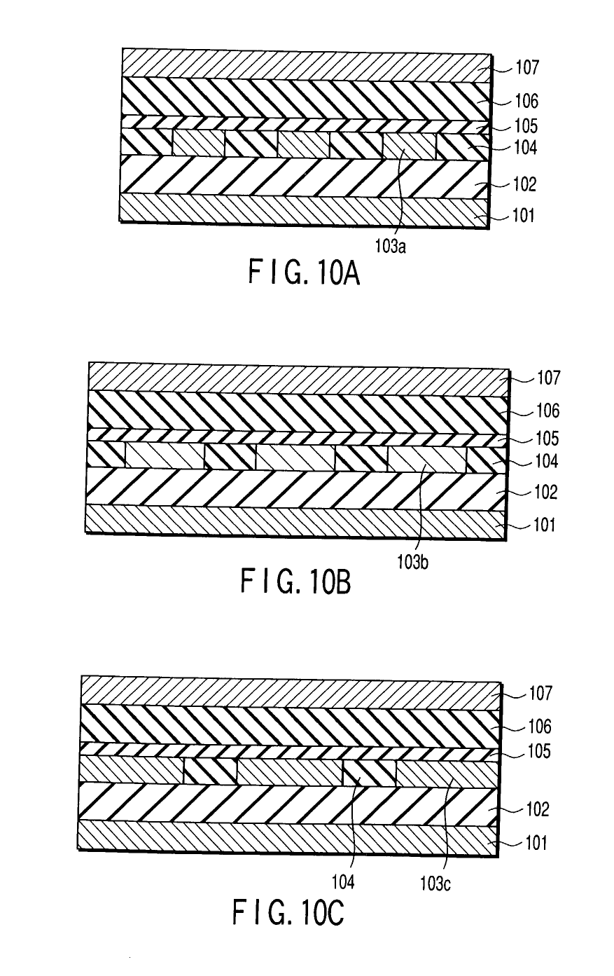

FIGS. 10A to 10C are views showing the structure of the TEG according to a third example of the present invention. In the above-described embodiment, there is provided the TEG in which the intervals of the pitch wirings are designed to be equal and the wiring widths are different from each other.

In this example, the wirings widths W of the second wiring layers 103a to 103c are different from each other in accordance with each of three samples, and a quantity of total displacement ΔW of the wiring width is determined as a process variable. In this example, since the measurement values of the capacities C12 and C23 can be increased, the measurement accuracy of the film thicknesses T1, T3 and T4 and the dielectric constants ε1, ε3 and ε4 can be improved.

### FOURTH EXAMPLE

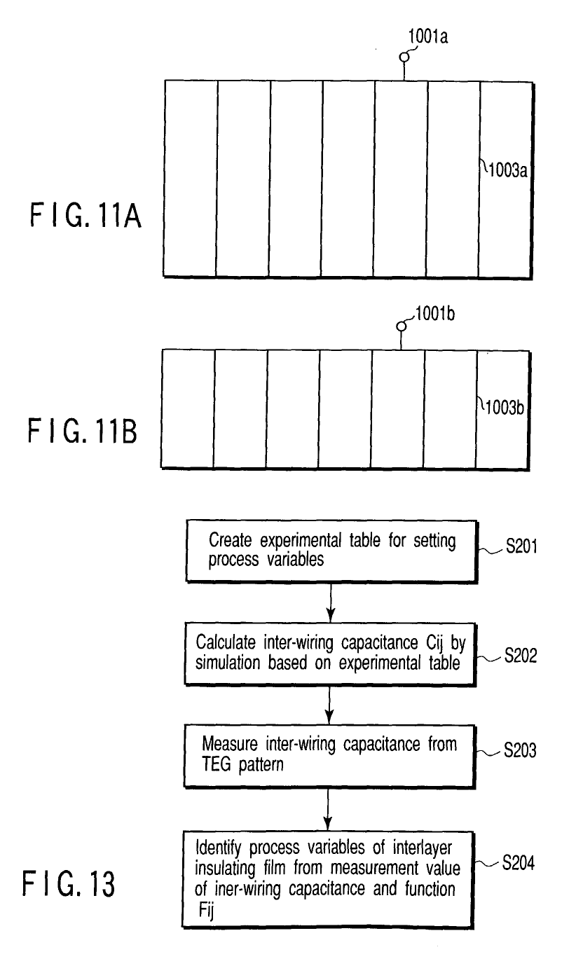

FIGS. 11A and 11B are views shwoing an example of the structure of the second wiring layer of the TEG samples shown in FIGS. 1A to 1C. In this example, each second wiring layer 1003 is connected to a common electrode 1001. As a result, although two electrode outgoing lines 2a and 2b are required with respect to the second wiring layer 103 in the second example, one line can suffice, thereby reducing a pad area. In this embodiment, since C22 is not measured, a number of TEGs must be increased instead.

(Second Embodiment)

In the method described in connection with the first embodiment, three TEG patterns are formed, and the inter-wiring capacity must be measured from each pattern. In this embodiment, description will be given as to a method which identifies the process variable from one TEG pattern.

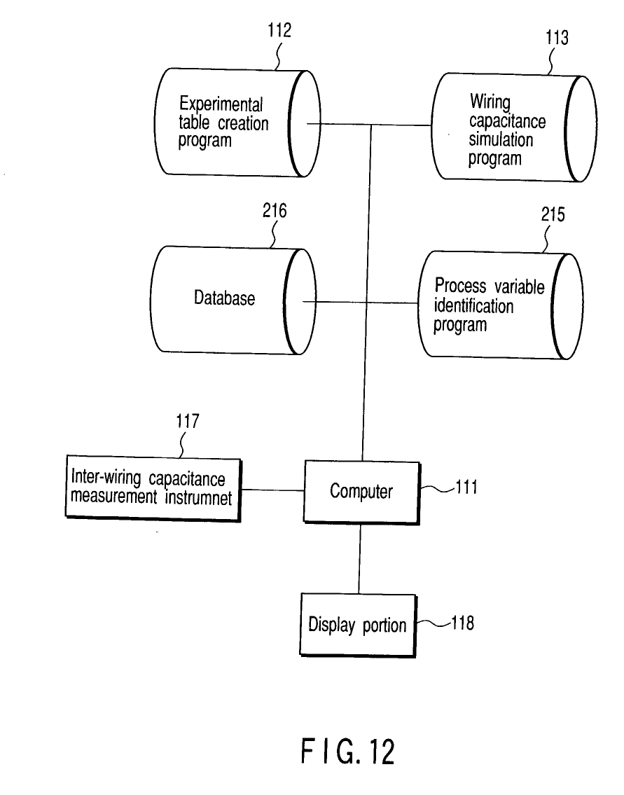

FIG. 12 is a block diagram showing a schematic structure of a data base construction apparatus. Further, FIG. 13 is a flowchart used for explanation of the process variable identification methdo according to a sixth embodiment. Incidentally, in FIG. 12, like reference numerals denote parts equal to those in FIG. 2, thereby omitting their explanation.

(Steps S201 and S202)

Steps S201 and 202 are the same as the steps S101 and S102 described in connection with the first embodiment, thereby omitting the explanation.

(Step S203)

Each TEG sample is created by using a predetermiend process, and each interlayer capacity Cij of the created TEG sample is measured by the inter-wiring capacity measurement instrument 117.

(Step S204)

With respect to a combination of the obtained capacities Cij, a pair of the structure and material constants with minimum errors are sampled from the data base 216. By again repeating the wiring capacity simulation 113 using a hill-climbing method with the sampled pair being determined as a starting point, detailed sampling of the most suitable process variable is performed, and the process variable is identified.

With the above-described steps, even if there is no inline measurement data, basic identification of a pair of the structure and material constants can be determined in a short time.

Incidentally, the structure constants and the material constants are not identified from the capacity measurement value of one TEG, but the structure constants and the material constants may be identified from respective capacity values measured from a plurality of TEGs. The accuracy can be improved by using capacity values measured from a pluraltiy of TEGs.

The present invention is not restricted to the foregoing embodiments, and various modifications can be carried out without departing from the scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A process variable identification method with respect to a multi-layer wiring structure including a first wiring layer consisting of a plane electrode, a second wiring layer arranged on said first plane electrode and having a plurality of pitch wirings with a width W arranged at a pitch P, a third wiring layer arranged on said second wiring layer and having a plane electrode, and a plurality of interlayer insulating films isolating said first to third wiring layers from each other, said method comprising:
calculating an inter-wiring capacitance from process variables including at least a structural variable and a material constant of each interlayer insulating film;
modeling a function expression in which said process variables are determined as variables and said inter-wiring capacitance is determined as a response variable based on the relationship between said obtained inter-wiring capacitance and said process variables;
creating a plurailty of multi-layer wiring structures having widths of said pitch wirings or pitches different from each other and measuring an inter-wiring capacitance from each created multi-layer wiring structure; and
identifying said process variables of said actually created multi-layer wiring structure from said measured inter-wiring capacitance based on said modeled function expression.

2. The process variable identification method according to claim 1, wherein said structrue variable and said material constant of said interlayer insulating film are a film thickness and a dielectric constant, respectively.

3. The process variable identification method according to claim 1 or 2, wherein said capacity calculation portion calculates a plurality of relationships between a structure constant and a material constant of each interlayer insulating film and each inter-wiring layer capacity based on an experimental design method.

4. The process variable identification method according to claim 1 or 2, wherein said process variable includes a material constant of said interlayer insulating film formed between said pitch wirings.

5. The process variable identification method according to claim 1 or 2, wherein a plurality of multi-layer wiring structures having widths of pitch wirings or pitches different from each other are actually created as said second wiring layers, and each inter-wiring capacity of said each created multi-layer wiring structure is measured.

6. A process variable identification method comprising, in a multi-layer wiring structure including a first wiring layer consisting of a plane electrode, a second wiring layer which is arranged on said first plane electrode and has a plurality of pitch wirings with a width W arranged at a pitch P, a third wiring layer which is arranged on said second wiring layer and consists of a plane electrode, and a plurality of interlayer insulating films which insulate and separate said first to third wiring layers from each other:
a step of calculating a plurality of relationships between a structure variable and a material constant of each interlayer insulating film and a capacity between respective wiring layers;
a step of measuring an inter-wiring capacity between respective wirngs in said actually created multi-layer wiring structure; and
a step of selecting an inter-wiring capacity which coincides with a capacity measured from a calculated inter-wiring capacity and identifying a process variable corresponding to said selected inter-wiring capacity as a process vairable of said actually formed multi-layer wiring structure.

7. The process variable indentification method according to claim 6, wherein said structure variable and said material constant of said interlayer insulating film are a film thickness and a dielectric constant, respectively.

8. The process variable identification method according to claim 6, wherein said capacity calculation portion calculates a plurality of relationships between a structure constant and a material constant of each interlayer insulating film and a capacity between respective wiring layers based on an experimental design method.

9. The process variable identification method according to claim 6, wherein said process variable includes a material constant of said interlayer insulatnig film formed between said pitch wirings.

10. The process variable identification method according to claim 6, wherein a plurality of multi-layer wiring structures having widths of pitch wirings or pitches different from each other are actually created as said second wiring layers, and a capacity between respective wirings of each created multi-layer wiring sructure is measured.

11. A process variable identification apparatus comprising, with respect to a multi-layer wiring structure including a first wiring layer consisting of a plane electrode, a second wiring layer which is arranged on said first plane electrode and has a plurality of pitch wirings with a width W arranged at a pitch P, a third wiring layer which is arranged on said second wiring layer and consists of a plane electrode, and a plurality of interlayer insulating films which insulate and separate said first to third wiring layers from each other:
a capacity calculation portion which calculaets an inter-wiring capacity from process variables including at least a geometric shape and a material constant of each interlayer insulating film;
a function expression generation portion which models a function expression in which said process variables are determiend as variables and said inter-wiring capacity is determiend as a response variable from the relationship between said obtaiend inter-wiring capacity and said process variable;
an inter-wiring capacity measurement portion which measures an inter-wiring capacity between respective wirings from said actually formed multi-layer wiring structure; and
means for identifying said process variable based on said function expression modeled in said function expression generation portion and said inter-wiring capacity measured in said inter-wiring capacity measurement portion.

12. A process variable identification apparatus comprising, in a multi-layer wiring structure including a first wiring layer consisting of a plane electrode, a second wiring layer which is arranged on said first plane electrode and has a plurality of pitch wirings with a width W arranged at a pitch P, a third wiring layer which is arranged on said second wiring layer and consists of a plane electrode, and a plurality of interlayer insulating films which insulate and separate said first to third wiring layers from each other:
a capacity calculation portion which calculates a plurality of relationships between process variables including at least a geometric shape and a material constant of each interlayer insulating film and a capacity between respective wiring layers;
a capacity measurement portion which measures an inter-wiring capacity between said respective wirings from said actually formed multi-layer wiring structure; and
an identification portion which selects an inter-wiring capacity which coincides with an inter-wiring capacity measured in said capacity measurement portion from inter-wiring capacities calculated in said capacity calculation protion, and identifies said process variables of said actually formed multi-layer wiring structure.

13. An evaluation sample comprising TEGs, each including:
a first wiring layer consisting of a plane electrode;
a second wiring layer arranged on said first plane electrode and having a plurality of pitch wirings with a width W arranged at a pitch P;
a third wiring layer arranged on said second wiring layer and having a plane electrode; and
a plurality of interlayer insulating films isolating said first to third wiring layers from each other,
wherein said evaluation sample comprises a plurality of TEGs having widths of said pitch wirings or pitches different from each other.

14. An evaluation sample according to claim 13, further comprising two electrodes connected to said pitch wirings, said pitch wirings adjacent to each other being connected to said electrodes different from each other, respectively.

15. An evaluation sample according to claim 13, wherein all said pitch wirings are connected to a common electrode.
